(19) United States
(12) Patent Application Publication
(10) Pub. No.: US 2010/0128870 A1
(43) Pub. Date: May 27, 2010

(54) PSEUDO-RANDOM NUMBER GENERATION DEVICE, PROGRAM, AND METHOD FOR STREAM ENCODING

(76) Inventors: Yukiyasu Tsunoo, Tokyo (JP); Hiroyasu Kubo, Ishikawa (JP); Tomoyasu Suzaki, Ishikawa (JP); Teruo Saito, Ishikawa (JP); Hiroki Nakashima, Ishikawa (JP)

Correspondence Address: Mr. Jackson Chen, 6535 N. STATE HWY 161, IRVING, TX, 75039, US

(21) Appl. No.: 12/593,391

(22) PCT Filed: Mar. 25, 2008
(86) PCT No.: PCT/JP2008/055599

§ 371 Date: Sep. 28, 2009

(30) Foreign Application Priority Data
Mar. 27, 2007 (JP) 2007-081755

(51) Int. Cl. H04L 9/26; H04L 9/00; H04L 9/18

(52) U.S. Cl. 380/46

(57) ABSTRACT

A pseudorandom number generation apparatus used for a stream cipher comprises at least one internal state, a non-linear conversion means that updates numeric data saved in the internal state, and a transposition means that performs only bit transposition for the numeric data, updated by the non-linear conversion means, based on a predefined rule.

### CROSS-REFERENCE TO RELATED APPLICATIONS

The present application claims priority from Japanese patent application 2007-081755 (filed on Mar. 27, 2007) the content of which is hereby incorporated in its entirety by reference into this specification.

### TECHNICAL FIELD

The present invention relates to an encryption device for concealing data when data is communicated or accumulated, and more particularly to a device, program, and method advantageously applicable to a stream cipher that can encrypt data at a high speed and random number generation that is used for encryption.

### BACKGROUND ART

### General Description of Stream Cipher

The common key cryptosystem, one of the methods for concealing data, is classified roughly into a block cipher and a stream cipher.

A typical stream cipher comprises a pseudorandom number generation unit (key stream generation unit) that generates a pseudorandom number sequence (key stream) and a combination unit that combines a pseudorandom number sequence with a plaintext.

A pseudorandom number sequence is generated with a secret key, or a secret key and an initial vector, as the seed, and the generated pseudorandom number sequence and plaintext are xored (combination unit) to generate ciphertext.

To decrypt ciphertext, a pseudorandom number sequence is generated from the seed used for the encryption, and the generated pseudorandom number sequence and ciphertext are xored (exclusive ORed) to generate plaintext.

That is, let P be plaintext, C be ciphertext, R be a pseudorandom number sequence, and the symbol(+) be a symbol representing an exclusive OR. Then, the following relations hold.

P(+)R=C, and

C(+)R=P

### <Safety of a Stream Cipher>

In a stream cipher, a generated pseudorandom number sequence is used for the simple processing such as the exclusive OR operation in many cases. This means that the safety of a stream cipher depends on the safety of a generated pseudorandom number sequence.

In general, the property of a pseudorandom number sequence used for a stream cipher includes unpredictability, statistical uniformity, non-correlation, long periodicity, and non-linearity.

“True random numbers” are non-periodic and completely uncorrelated. True random numbers are generated, for example, by rolling a dice or by using natural phenomena. That is, if the generated pseudorandom number sequence satisfies the property described above, it is said that the stream cipher is safe.

Conversely, if information indicating that the generated pseudorandom number sequence is distinguishable from true random numbers is found, it is considered that the safety of the stream cipher is somewhat low.

### <Example of a Method for Evaluating Safety of a Stream Cipher>

Based on the concept described above, a method is provided for estimating the safety of a stream cipher.

A cryptographic attack method of indicating that output ciphertext or pseudorandom numbers are distinguishable from true random numbers is termed a distinguishing attack.

Output ciphertext or pseudorandom numbers are determined to be distinguishable from true random numbers if it is shown that they have statistical biases or statistical characteristics.

In the distinguishing attack, means for showing such biases or characteristics is termed a distinguisher, and discovering or creating means for showing such biases or characteristics is termed configuring a distinguisher.

If a distinguisher may be configured, a distinguishing attack may be applied.

If a distinguishing attack may be applied to a cipher, the cipher is not safe because the cipher may leak internal information of the plaintext or the key.

Thus, if modifications are added to a cipher, to which a distinguishing attack may be applied, and the distinguishing attack cannot be applied thereto, it can be said that the safety of the cipher is increased.

### <Example of a Stream Cipher>

An example of a stream cipher is Mir-1. Mir-1, proposed by Maximov in 2005, is a stream cipher submitted to eSTREAM.

Mir-1 is a stream cipher that updates the internal state using a function called T-function and, with updated data as the key for each round, generates a key stream through the scrambling by an S-box whose entries change depending upon a secret key.

A T-function is a cryptographic, basic function proposed in 2002 by Klimov and Shamir in the article given below (Non-Patent Document 2).

The T-function does not have algebraic features such as a linear relational expression that is satisfied by the bits except for the lowest bits while maintaining the longest period of data generated by concatenating the internal state.

Conventionally, the linear feedback shift register (LFSR) is known for the processing that guarantees the longest period. Data updated by the LFSR has an algebraic feature that all bits have a linear relation.

Therefore, there is a danger that an attacker might use the algebraic feature of the LFSR to represent internal data with simultaneous equations and solve the simultaneous equations for applying an algebraic attack to obtain the internal data.

For this reason, the T-function is expected to be used in a stream cipher as a replacement component for the LFSR.

Thereafter, several stream ciphers using the T-function are proposed, however, the analysis based on the characteristics of the T-function shows that the proposed stream ciphers are not a cipher that is sufficiently safe.

Mir-1 adopts an algorithm that uses in its basic structure the T-function and S-box, considering that a 64-bit processor, which will become a mainstream processor in future, will perform fast processing with less memory.

Mir-1, which uses the T-function instead of the LFSR, is expected to be more resistant against an algebraic attack.

### <Point of an Attack Method to be Targeted by the Invention>

In Mir-1, a distinguisher configured using three continuous rounds of output data occurs with a probability higher than a probability with which a distinguisher configured using a true random number sequence occurs.

With this distinguisher, the output data of Mir-1 can be distinguished from the output data generated using the true random number sequence when the amount of data reaches about two to tenth power.

### <Description of Mir-1 Algorithm for Showing an Example of an Attack Method>

Before describing the Mir-1 algorithm, the notation and definition of variables will be described.

A bitwise exclusive OR, logical product, and logical sum are denoted respectively as (+), &, and |.

Addition and multiplication in modulo two to the 64th power are denoted respectively as + and .

The left rotation shift of t bits of the one-word variable X (64 bits) is denoted as

X<<<t, or

ROLt(X).

A word X on a byte basis and on a bit basis is defined as follows. The symbol ∥ means the concatenation of data.

X=X.byte7∥X.byte6∥ . . . X.byte0=X.bit63∥X.bit62∥ . . . X.bit0

The Mth bit to the Nth bit of the word X is defined as X[M,N]. X[M,N] is represented as follows using the representation given above.

X[M,N]=X.bitN∥X.bit(N−1)∥ . . . ∥X.bit(M)

Mir-1 uses the 128-bit secret key and the 64-bit initial vector IV, which are denoted as follows.

KEY=k.byte15∥k.byte14∥ . . . ∥k.byte0

IV=IV.byte7∥IV.byte6∥ . . . ∥IV.byte0

The key stream generation processing of Mir-1 will now be described.

The key stream generation processing of Mir-1 is divided roughly into the following two parts.

Loop State Update(called “LS Update”)

Automata State Update(called “AS Update”)

FIG. 5 shows the algorithm of LS Update of Mir-1. As shown in FIG. 5, LS Update has four 64-bit registers xi(0≦i≦3) and updates the registers xi using the multi-word T-function.

The 256-bit output (x0∥x1∥x2∥x3) of LS Update is guaranteed to have the longest period of 2 to the 256th power.

FIG. 6 shows the algorithm of AS Update of Mir-1. AS Update has two 64-bit registers A and B and calculates A′ and B′ using an update function 31. A′ and B′ become A and B with no change.

The register values used in this calculation, which are passed from LS Update, are the values each of which is 64-bit data created by concatenating the high-order 32 bits of (x0,x1,x2,x3), and each word is denoted as follows.

(x(i+2)[32,63]∥xi[32,63])(i=0,1)

In the description below, those words are represented as follows.

x20=(x2[32,63]∥x0[32,63]),

x31=(x3[32,63]∥xi[32,63])

In the key stream generation processing of Mir-1, LS Update and AS Update are executed each round, and 64-bit B′ calculated by AS Update is output as the key stream z.

Next, the initialization processing of Mir-1 will be described. The initial processing is executed before the key stream generation processing.

The initialization processing of Mir-1 is divided roughly into two parts: Key Setup and IV Setup.

FIG. 7 shows the algorithm of Key Setup of Mir-1. In Key Setup, registers xi(i=0−3) and registers A and B are initialized using the 128-bit secret key. In the figure, C0 and C1 are constants shown in FIG. 5.

In Key Setup, an S-box, which is termed a “secret S-box” and varies according to the value of the secret key, is generated first by expression (1) given below.

In this expression, SR[] means the S-box used by AES (Advanced Encryption Standard) and the value is calculated for each of the entries i=0, . . . , 255.

S−box[i]=SR[ . . . SR[SR[i(+)k.byte0](+) . . . k.byte1](+) . . . (+)k.byte15] (1)

FIG. 8 shows the algorithm of IV Setup of Mir-1. IV Setup uses the 64-bit initial vector to update the registers xi(0≦i≦3) and registers A and B that are initialized by Key Setup.

### <Description of a Mir-1 Attack Method Distinguishing Attack to be Targeted by Present Invention>

The following describes the property of IV Setup and LS Update of Mir-1 when applying a distinguishing attack. Note that Key Setup does not affect a distinguishing attack.

First, the following describes the structural property of IV Setup.

In IV Setup, the 64-bit IV is divided into eight 8-bit pieces (IV.byte0-IV.byte7) and each piece, whose value is replaced using the secret S-box, is xored with each register, and the resulting value is stored in that register, as shown in FIG. 8.

Assume that the bytes of the IV each have the same value, for example, IVa=(a∥a∥ . . . ∥a).

Because of the property of the exclusive OR operation, xoring the same values gives the result of 0 and, as a result, the data xored in IV Setup is as shown in FIG. 9. FIG. 9 is a diagram showing the property of IV Setup and showing that, when an IV composed of the same-value bytes is given to IV Setup, a problem is generated; for example, each word is xored with the data composed of the same-value bytes or is not affected by the IV.

For example, the registers (x0,x1,x2,x3) are not affected by the IV in step 2 as shown in FIG. 9.

In addition, in steps 1 and 3, the data xored with the registers xi.byte4(i=0˜3), A.byte0, A.byte4, B.byte0, B.byte4 is the same data that is S[a].

Although the entries of the Secret S-box are unknown because they depend on the secret key, it is understood that all registers are xored with the same value.

Next, the property of LS Update will be described.

In the multi-word T-function, the nth bit of each word is affected only by bits 0-n of the whole word.

If the difference (abbreviated to “difference”), Δi, calculated as an exclusive OR is given to registers xi(i=0−3) at the start time of LS Update as in the differential analysis of the block cipher and if bits 0-n of the difference, Δi, are all zeros (no difference), the difference in bits 0-n of the registers xi is always 0, regardless of the number of executions of LS Update, that is, no difference is generated.

This is because the calculation performed in LS Update(T-function) affects only the high-order digits.

As shown in FIG. 9, IVa composed of the same-value bytes is given in LS Update, bits 0-31 of registers xi(i=0−3) are not affected by the IV.

Therefore, while the secret key is fixed (the result of Key Setup is the same), no difference is generated in bits 0-31 of registers xi regardless of the number of executions of LS Update even if IVa is changed under the condition that all bytes have the same value.

### <Differential Attack Using a Chosen IV>

The following describes an analysis method using the two properties given above.

First, assume that the following three are satisfied as the condition for the attack.

The secret key remains fixed during the attack.

The IV may be chosen freely by the attacker.

The attacker is able to get the key stream freely.

First, in IV Setup, the registers are initialized by the following pair each of which is composed of the same-value bytes.

IVa=(a∥a∥ . . . ∥a)and

IVb=(b∥b∥ . . . ∥b)

Let xai be registers when IVa is given and

let xbi be registers when IVb is given.

Then, from the structural property of IV Setup, the difference between the low-order 32 bits between xai and xbi (i=0−3) is zero.

xai[0,31]=xbi[0,31](i=0˜3) (2)

In addition, because register xi.byte4 is xored with S[a] and S[b] respectively as in step 1 in FIG. 9, the expressions are shown by the following expressions (3a) and (3b). (The operator (+) indicates exclusive OR).

xai.byte4=xi.byte4(+)S[a](i=0˜3) (3a)

xbi.byte4=xi.byte4(+)S[b](i=0˜3) (3b)

If the following is satisfied though the entries of the secret S-box are unknown at this time,

S[a]&0×1=S[b]&0×1 (4)

then, bit 32 of the registers xai and bit 32 of registers xbi satisfy the relation (5) given below.

xai.bit32=xbi.bit32(i=0˜3) (5)

Therefore, if the condition given by expression (4) is satisfied in IV Setup when IVa and IVb, each composed of the same-value bytes, are given, the following expression (6) is satisfied because of the relation indicated by expression (2) and expression (5).

xai[0,32]=xbi[0,32](i=0˜3) (6)

That is, the relation of the low-order 33 bits of registers xi, updated by IVa and IVb, is that the difference becomes zero.

From the property of LS Update, the relation given by expression (4) is always maintained in IV Setup and the key stream generation processing, regardless of the number of times LS Update is executed.

Next, the key stream generation processing will be described on the assumption that the condition given by expression (4) is satisfied.

FIG. 10 is a diagram showing the state transition of three rounds of update processing performed by AS Update.

Data at time t is represented as X̂(t).

Although AS Update performs addition in modulo 2 to the 64th power, it is possible to replace the addition by the exclusive OR by decrypting only the lowest bit.

FIG. 11 is a diagram showing that a distinguisher is configured by using the three continuous rounds of key streams with only the lowest bit taken into consideration and is a diagram showing that the addition in modulo 2 to the 64th power in FIG. 10 is replaced by the exclusive OR with only the lowest bit taken into consideration.

Next, the configuration method of a distinguisher will be described.

Let za and zb be the key streams generated from IVa and IVb respectively.

Let (xa20, xa31) and (xb20, xb31) be data inserted by LS Update when IVa and IVb are given.

At this time, the expressions developed for the lowest bit in the secret S-box output position (81 in FIG. 11) at time t are shown by expressions (7a) and (7b) given below.

{ROL29(zâ(t−1))(+)zâ(t)(+)xa31̂(t−1)(+)xa20̂(t)(+)zâ(t+1)}.bit0=S[zâ(t)].bit0 (7a)

{ROL29(zb̂(t−1))(+)zb̂(t)(+)xb31̂(t−1)(+)zb20̂(t)(+)zb̂(t+1)}.bit0=S[zb̂(t)].bit0 (7b)

Here, the following relations (8) and (9) are satisfied because of expression (5).

xa20̂(t).bit0=xb20̂(t).bit0 (8)

xa31̂(t−1).bit0=xb31̂(t−1).bit0 (9)

If the time t satisfying

zâ(t).byte0=zb̂(t).byte0 (10)

is selected in the key streams generated from IVa and IVb, the outputs of the secret S-box are the same because the inputs are the same even if the entries of the secret S-box are unknown and therefore the following relation is satisfied.

S[zâ(t)]=S[zb̂(t)] (11)

Therefore, from expression (8)-expression (11), the following relational expression (12) holds.

{ROL29(zâ(t−1)(+)zb̂(t−1))(+)zâ(t+1)(+)zb̂(t+1)}.bit0=0 (12)

In summary, if any given pair of IVa and IVb satisfies expression (4), expression (12) is always satisfied at time t at which expression (10) holds.

Next, the following describes that expression (12) may be used as a distinguisher.

<Probability with which a Distinguisher Exists and Required Amount of Data>

The probability with which expression (12), which is used as a distinguisher holds, will now be described.

If a key stream output by Mir-1 is a true random number sequence, the probability with which expression (12), which is used as a distinguisher, holds, is ½.

In the following description, it is assumed that the internal states, updated by different IVs, and the key streams are independent and the key streams are uniformly distributed.

First, the probability with which expression (10) holds is two to the negative eighth power. Note that, because the key stream is a value known to an attacker and may be selected, expression (10) may always be satisfied.

Next, the probability with which expression (4) holds is ½ because it is the probability with which a match occurs in the lowest bit of randomly selected secret S-box entries.

If the probability with which expression (12) holds is ideally assumed to be ½, when expression (4) does not hold, the probability Pd with which expression (12) holds in the output sequence of Mir-1 is as follows.

$$\begin{matrix}Pd = 1 \times 1 / 2 + 1 / 2 ( 1 - 1 / 2 ) \\ = 1 / 2 ( 1 + 1 / 2 )\end{matrix} \qquad ( 13 )$$

Thus, this probability is higher than ½ that is the probability when the key stream is a true random number sequence.

Next, the following describes the amount of data necessary for distinguishing between the output sequence of Mir-1 and the true random number sequence, when expression (12) is used as a distinguisher.

Non-Patent Document 3 (I. Mantin, and A. Shamir: “A Practical Attack on Broadcast RC4,” Fast Software Encryption, FSE 2001, LNCS 2355, pp. 152-164, Springer-Verlag, 2001.) shows that the amount of data necessary for distinguishing between the two distributions is as follows.

When an event e occurs in the event distribution X in which an event occurs with the probability of p and in the event distribution Y in which an event occurs with the probability of p(q+1), distinguishing between X and Y with a reliable success probability requires a sample of O(1/(pq squared)).

Note that the theorem described above is satisfied only when p is sufficiently low.

Non-Patent Document 4 (S. Paul, B. Preneel, and G. Sekar: “Distinguishing Attacks on the Stream Cipher Py,” eSTREAM, the ECRYPT Stream Cipher Project, Report 2005/081, 2005.) shows that, when p=½, the amount of data necessary for distinguishing between the two distributions is as follows.

When an event e occurs in the event distribution X in which an event occurs with the probability of p=½ and in the event distribution Y in which an event occurs with the probability of ½(q+1), distinguishing between X and Y with a reliable success probability requires a sample of O(1/(q squared)).

The event e in the decryption using the distinguisher described above is an event for which expression (12) holds. The distribution of the event e in the random numbers may be regarded as X, and the event e in the output sequence of Mir-1 may be regarded as Y.

Therefore, because it is considered that p=½ and q=½, the amount of data necessary for decryption is O(two squared).

Considering that the key stream satisfying expression (10) is selected, the amount T of data necessary for decryption is

$$\begin{matrix}T = two to the eighth power \times O ( 2 squared ) \\ = O ( two to the tenth power )\end{matrix} \qquad ( 14 )$$

By applying the chosen IV attack, the output sequence of Mir-1 and the true random number sequence may be distinguished theoretically using the key stream of about two to the tenth power words.

### Non-Patent Document 1:

A. Maximov, “A New Stream Cipher “Mir-1,” ECRYPT Stream Cipher Project, Report 2005/017, 2005.

### Non-Patent Document 2:

A. Klimov, and A. Shamir, “A New Class of Invertible Mappings,” CHES'02, LNCS 2523, pp. 470-480, Springer Verlag, 2002.

### Non-Patent Document 3:

I. Mantin, and A. Shamir: “A Practical Attack on Broadcast RC4,” Fast Software Encryption, FSE 2001, LNCS 2355, pp. 152-164, Springer-Verlag, 2001.

### Non-Patent Document 4:

S. Paul, B. Preneel, and G. Sekar: “Distinguishing Attacks on the Stream Cipher Py,” eSTREAM, the ECRYPT Stream Cipher Project, Report 2005/081, 2005.

### DISCLOSURE OF THE INVENTION

### Problems to be Solved by the Invention

The disclosed contents of Non-Patent Documents 1-4 given above are hereby incorporated by reference into this specification. An analysis of the technology related to the present invention will now described.

A problem with the output sequence of Mir-1 is that the safety is low, because, when an attacking method is used in which expression (12) is used as a distinguisher, the key stream can be distinguished from the true random number sequence with a high probability.

Therefore, it is an object of the present invention to provide an encryption device, method, and program that make it difficult to configure a distinguisher in a stream cipher such as Mir-1 and that do not reduce the speed performance of Mir-1.

### Means to Solve the Problems

To solve the problem described above, the invention disclosed by this application provides the following general configuration.

The present invention provides a pseudorandom number generation device, used for a stream cipher, that comprises one or more internal states; non-linear conversion means that updates numeric data saved in the internal states; and transposition means that performs bit transposition for the numeric data, updated by the non-linear conversion means, based on a predefined rule.

According to the present invention, the internal state is updated each time a pseudorandom number sequence is output, the internal state is updated more frequently than a pseudorandom number sequence is output, or the internal state is updated less frequently than a pseudorandom number sequence is output.

According to the present invention, a rule for the bit transposition is changed according to a value of a predefined table.

### EFFECT OF THE INVENTION

The present invention makes it difficult to configure a distinguisher in a stream cipher, for example, Mir-1, with no reduction in the processing performance.

### BRIEF DESCRIPTION OF THE DRAWINGS

FIG. 1 is a flowchart showing the procedure of an exemplary embodiment of the present invention.

FIG. 2 is a diagram showing the configuration of an exemplary embodiment of the present invention.

FIG. 3 is a diagram showing an example of the transposition means in an exemplary embodiment of the present invention.

FIG. 4 is a diagram showing the operation of an exemplary embodiment of the present invention.

FIG. 5 is a diagram showing the algorithm of LS Update of Mir-1.

FIG. 6 is a diagram showing the algorithm of AS Update of Mir-1.

FIG. 7 is a diagram showing the algorithm of Key Setup of Mir-1.

FIG. 8 is a diagram showing the algorithm of IV Setup of Mir-1.

FIG. 9 is a diagram showing the property of IV Setup.

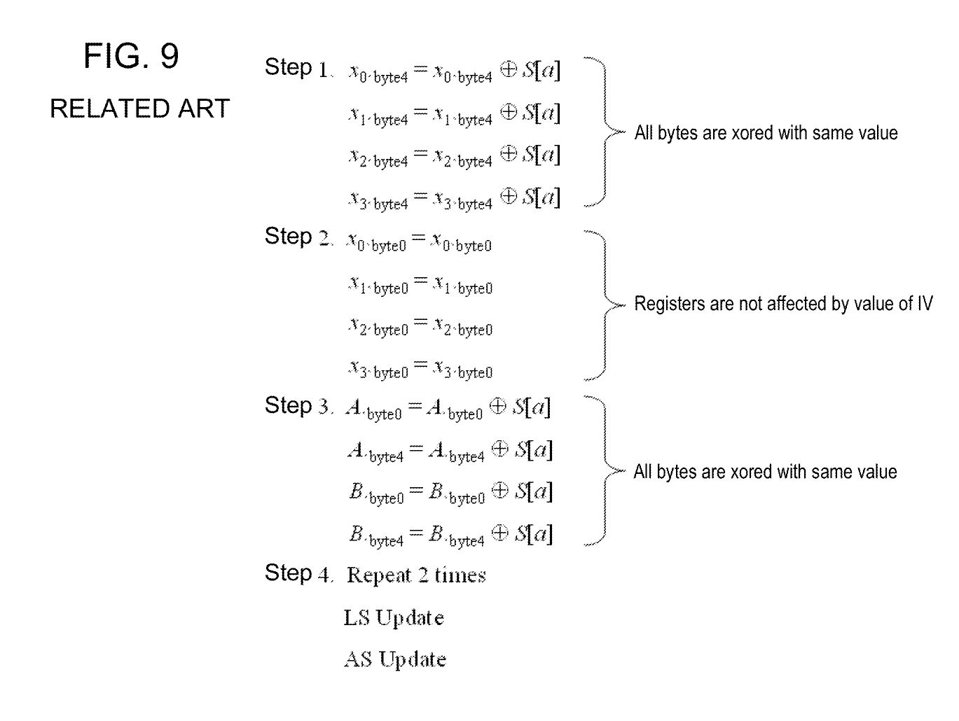

FIG. 10 is a diagram showing the state transition of three continuous rounds of AS Update.

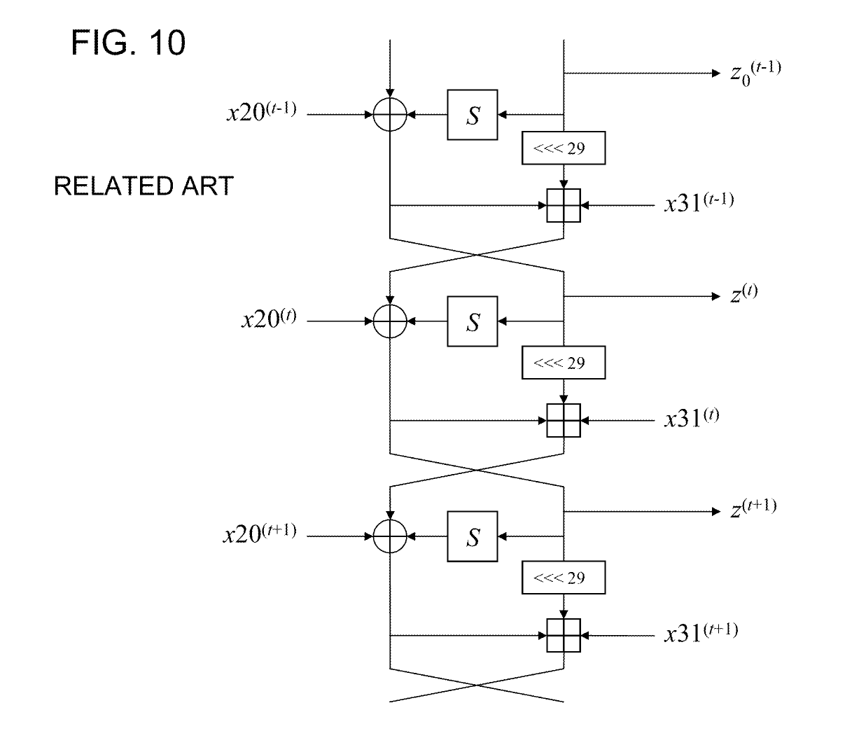

FIG. 11 is a diagram showing the configuration of a distinguisher.

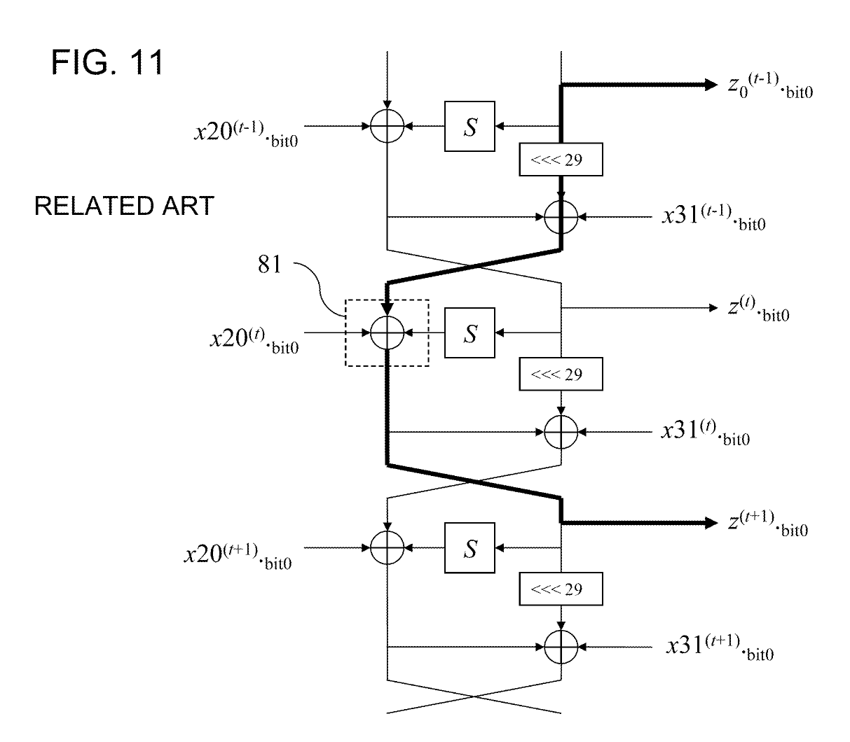

### EXPLANATIONS OF SYMBOLS

11 Internal state
12 Non-linear conversion means
13 Transposition means
31 Update function
81 S-box output position
90,94,901,902,903,904,941,942 Internal state
91,95 Non-linear conversion means
92 Selector
93,931,932,933,934 Transposition means
96,97 Processing
111 Key Setup
112 Selector switching
113 IV Setup
114 Selector switching
115 Key stream generation processing
921-928 Selector output

### PREFERRED MODES FOR CARRYING OUT THE INVENTION

### Items of Output Data

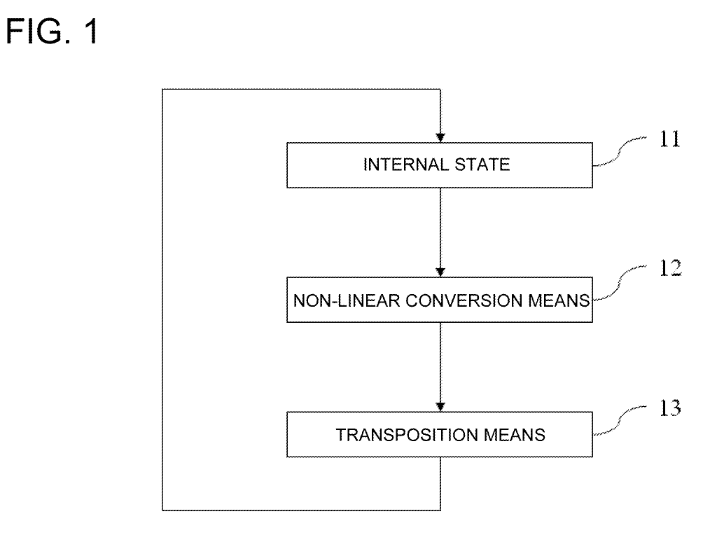

FIG. 1 is a diagram showing the configuration of an exemplary embodiment of the present invention. The present invention prevents “a differential attack using a chosen IV” from being applied. More specifically, in the present invention, there are provides a transposition means 13 that performs bit transposition based on a rule after updating an internal state 11 by a non-linear conversion means 12, which corresponds to the T-function, during the processing of IV Setup.

In the preset exemplary embodiment, the use of the transposition means 13 negates the property that bit n of the T-function is affected only by bits 0-n.

That is, because bit n of each word in the internal state is affected also by a bit in a position higher than that of bit n of the whole word, “a differential attack using a chosen IV” cannot substantially be applied.

As a result, the present invention solves the problem that the output sequence of the conventional Mir-1 is distinguishable from the true random number sequence with a higher probability and therefore the safety is low.

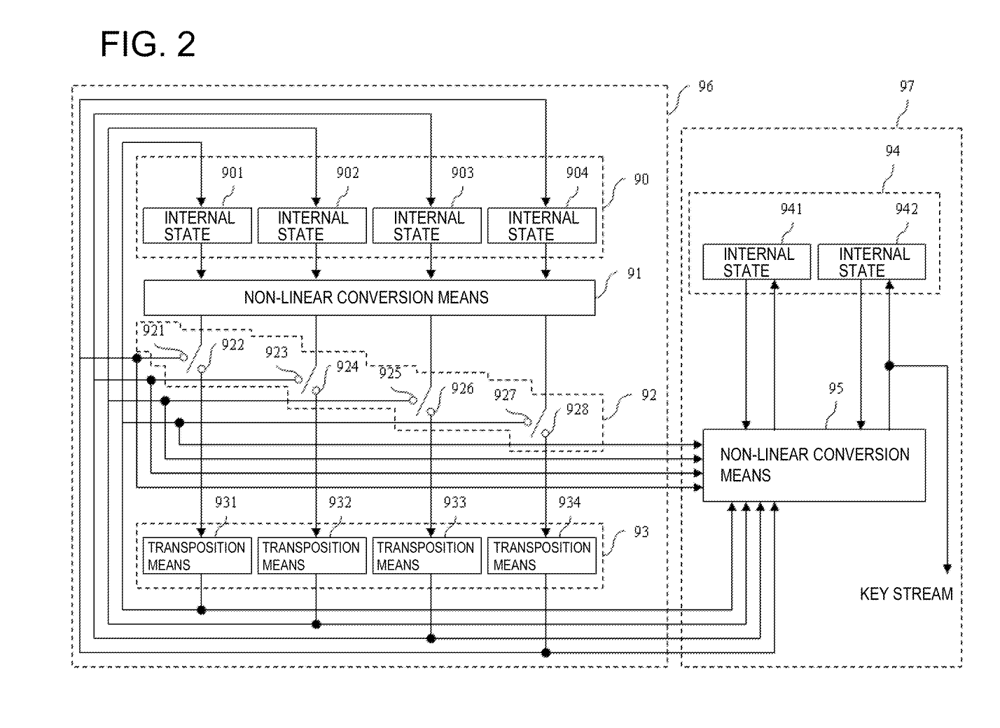

FIG. 2 is a diagram showing the configuration of an exemplary embodiment of the present invention shown in FIG. 1. As shown in FIG. 2, there are provided internal states 90 and 94, non-linear conversion means 91 and 95, a selector 92, and a transposition means 93. The internal state 90 comprises four internal states (registers) 901-904. The transposition means 93 comprises four transposition means 931-934. The selector 92 supplies four pieces of output data, received from the non-linear conversion means 91, either to the internal states 901-904 or to the transposition means 931-934. The internal state 94 comprises two internal states (registers) 941-942.

Numeric data held in the internal state 90 is input to the non-linear conversion means 91 for non-linear conversion.

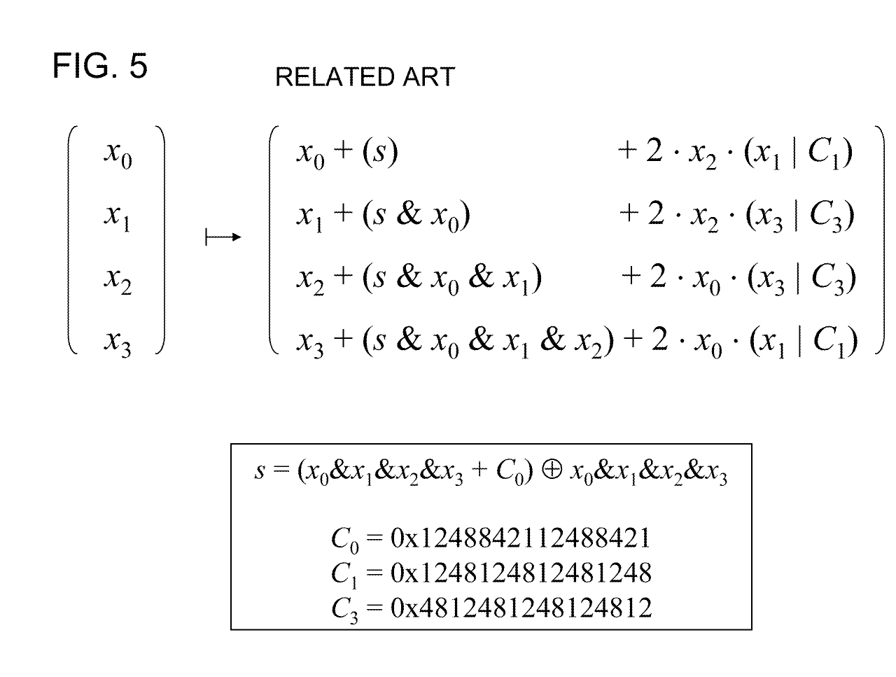

The non-linear conversion means 91 corresponds, for example, to the multi-word T-function (see FIG. 5).

The processing of data, output from the non-linear conversion means 91, is controlled by the selector 92.

When selector outputs 921, 923, 925, and 927 are selected, the data is returned to the internal state 90 and stored therein.

When selector outputs 922, 924, 926, and 928 are selected, the data is input to the transposition means 93.

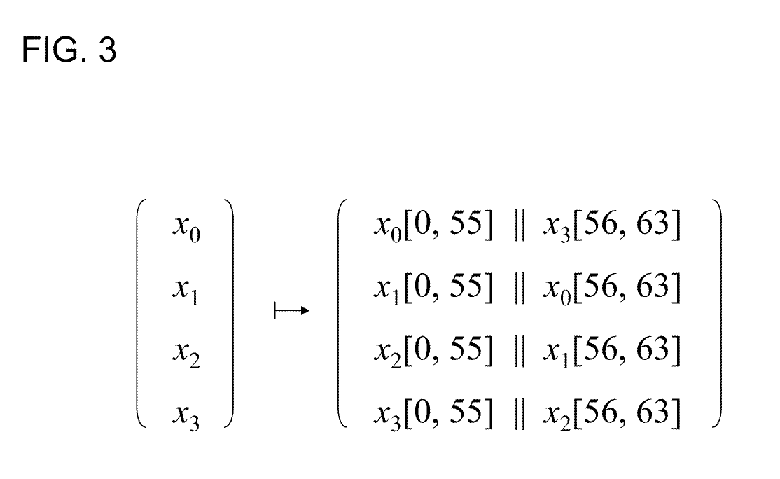

In this example, the transposition means 93 performs bit transposition processing shown in FIG. 3. That is, the transposition means 93 divides each 64-bit data into the high-order 8 bits and the low-order 56 bits, and performs the bit transposition processing in such a way that the high-order 8 bits are stored in the low-order 8 bits of another word.

For example, in the case of x0, the bits are transposed as follows.

The high-order 8 bits of x0 (x0[56,63]) are stored in the low-order 8 bits of x1.

The low-order 56 bits of x0 (x0[0,55]) are stored in the high-order 56 bits of x0.

The bit-transposed data is returned to the internal state 90 and stored therein.

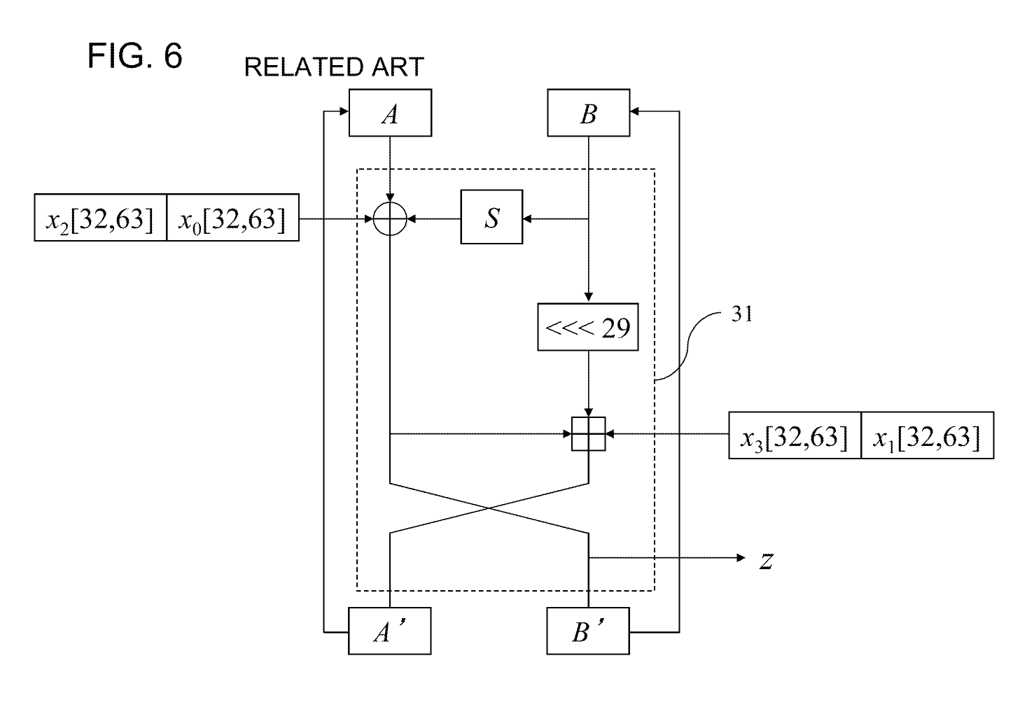

On the other hand, the data held in the internal states 941-942 is input to the non-linear conversion means 95 and this data, as well as the data that is output from the non-linear conversion means 91 or the transposition means 93, is non-linearly converted (corresponds to the processing of the update function 31 in FIG. 6).

The data converted by the non-linear conversion means 95 is returned to the internal states 941-942 and held therein. At this time, the data returned to the internal state 942 is output as a key stream.

The conventional method described above is a method using the property of the Mir-1 initial processing (LS Update and IV Setup). In this example, no change is added to the key stream generation processing (AS Update) of this conventional method.

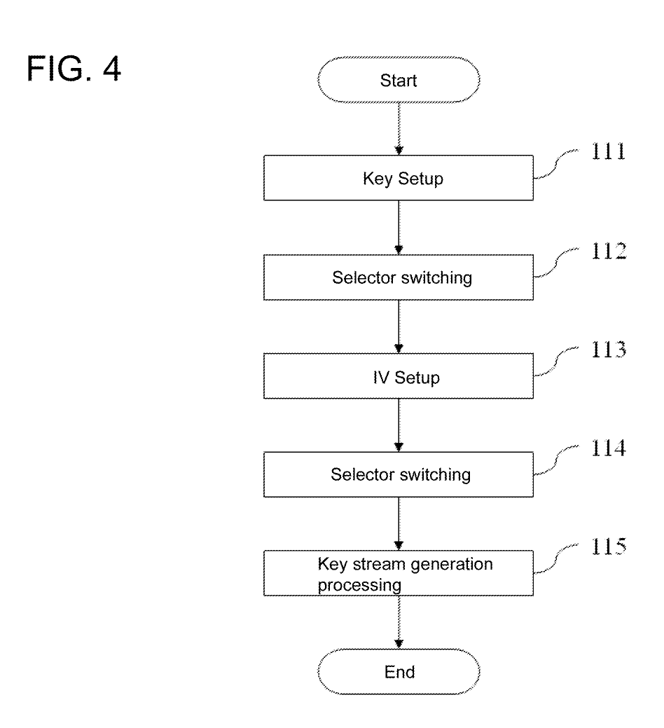

With reference to FIG. 4, an exemplary embodiment in which the present invention is applied to the initial processing will now be described.

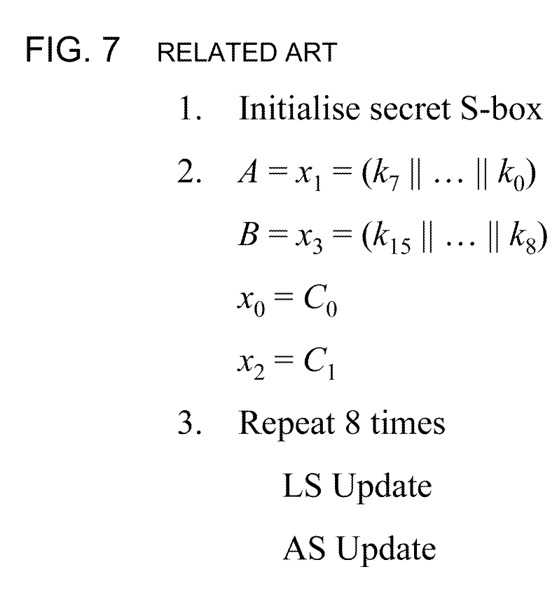

In the Key Setup step 111, there is no change from Key Setup of Mir-1 shown in FIG. 7. The correspondence between FIG. 2 and FIG. 7 is that x0-x3 are the internal state 90 and that A and B are the internal state 94.

The processing of 96 in FIG. 2 corresponds to LS Update, and the processing of 97 corresponds to AS Update. In this case, the selector 92 is set so that the transposition processing 93 is not performed (selector switching 112).

In FIG. 2, the non-linear conversion means 91 corresponds to FIG. 5, the transposition means 93 corresponds to FIG. 3, and the non-linear conversion means 95 corresponds to FIG. 6.

In the processing described above, the internal state is updated with a secret key as the input. In this case, the key stream is not output.

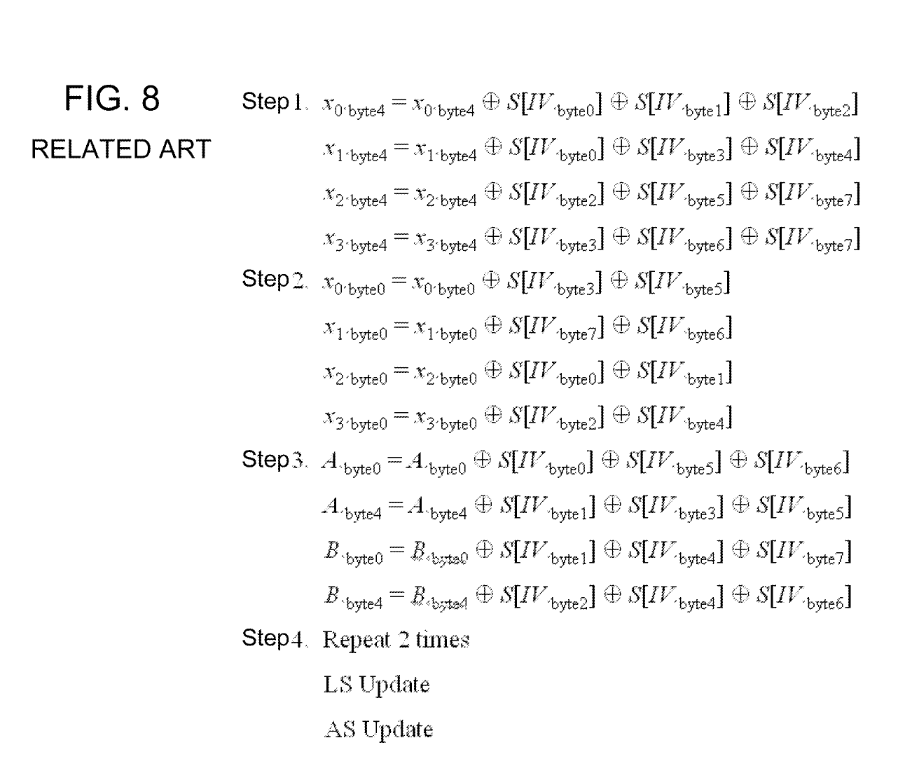

Next, in the IV Setup step 113, the IV insertion method is changed from the method shown in FIG. 8 to the method shown by expression (15) given below.

$$\begin{matrix}x 0 = x 0 ( + ) S [ IV ] x 1 \\ = x 1 ( + ) S [ ROL 16 ( IV ) ] x 2 \\ = x 2 ( + ) S [ ROL 32 ( IV ) ] x 3 \\ = x 3 ( + ) S [ ROL 48 ( IV ) ]\end{matrix} \qquad ( 15 )$$

S[X] means that data X is determined by referencing the S-box on a byte basis.

That is, S[X] means the following.

S[X]=S-box[X.byte7]∥S-box[X.byte6]∥ . . . ∥S-box[X.byte0] (16)

After the IV insertion, the selector 92 is set in such a way that the transposition processing 93 is performed, and the processing in FIG. 2 is performed twice. In this case, the key stream is not output.

After that, the selector 92 is set again in such a way that the transposition processing 93 is not performed (selector switching 114) and control is passed to the key stream generation processing 115.

In the key stream generation processing 115, the processing in FIG. 2 is repeated until the required key stream is obtained.

The following describes the effect achieved by the example shown in FIG. 4.

First, the change in the IV Setup step 113 ensures that a difference is stored in the words of the internal state even if an IV composed of the same-value bytes is given. That is, an IV that cancels an input difference cannot be given.

In addition, the transposition means 93 in FIG. 2 causes the byte position of a difference, stored in the internal state, to be shifted 16 bits, allowing the processing 96 to scramble the difference from the low-order bytes.

This change, if added, does not reduce the processing speed because there is no change in the number of times the S-box is referenced on an 8-bit basis or in the number of times the exclusive OR operation is performed.

The device according to the present invention, designed around an encryption algorithm for use on a 64-bit processor, can perform the exclusive OR operation directly on 64-bit variables, leading to an increase in the processing speed.

Next, the addition of the transposition means 93 causes the processing of the non-linear conversion means 91 to store a difference, inserted in bytes 4 of the internal state 90, into the higher-order side even if a chosen IV composed of the same-value bytes is given, and the transposition means 93 stores the difference into the low-order side and into the neighboring word.

Thus, even if a chosen IV composed of the same-value bytes is given, the difference of zero is not propagated in the update of the internal state 90 with the probability of 1.

The processing in FIG. 3 is the bijective mapping from 2 to the 256th power [symbol] 2 to the 256th power, and 2⁶⁴ variations of the IV pattern are guaranteed as the value immediately after the termination of IV Setup.

For this reason, the characteristics that the longest period of the T-function is guaranteed in the key stream generation processing are not affected. Although the processing speed of an actually installed device is reduced slightly, the reduction is not so significant considering that the device is based on the encryption algorithm specifically designed for a 64-bit processor.

As described above in detail, the present invention provides an encryption device that ensures high safety for concealing data when data is communicated or accumulated. In addition, the present invention provides an encryption device that does not reduce the processing performance of the conventional encryption.

While the present invention has been described with reference to the embodiment above, it is to be understood that the present invention is not limited to the configuration of the embodiment above and that modifications and changes that may be made by those skilled in the art within the scope of the present invention are included.

While the present invention has been described with reference to the embodiment above, it is to be understood that the present invention is not limited to the embodiment above and that modifications and changes that may be made by those skilled in the art within the scope of the claims included in the claims of this application are included.

The embodiment and the example may be changed and adjusted in the scope of all disclosures (including claims) of the present invention and based on the basic technological concept thereof. In the scope of the claims of the present invention, various disclosed elements may be combined and selected in a variety of ways.

What is claimed is:

1. A pseudorandom number generation apparatus used for a stream cipher, comprising:
at least one internal state;
a non-linear conversion means that updates numeric data saved in the internal state; and
a transposition means that performs only bit transposition for the numeric data, updated by the non-linear conversion means, based on a predefined rule.

2. The pseudorandom number generation apparatus as defined by claim 1 wherein
the internal state is updated
more frequently than a pseudorandom number sequence is output.

3. (canceled)

4. (canceled)

5. A program that generates pseudorandom numbers used for a stream cipher, the program causing a computer to execute:
a non-linear conversion processing that updates numeric data saved in at least one internal state; and
a transposition processing that performs only bit transposition for the updated numeric data based on a predefined rule.

6. The program as defined by claim 5, wherein
the internal state is updated
more frequently than a pseudorandom number sequence is output.

7. (canceled)

8. A computer-readable recording medium in which the program as defined by claim 5 is recorded.

9. A pseudorandom number generation method used for a stream cipher, comprising:
a non-linear conversion step of updating numeric data saved in at least one internal state; and
a transposition step of performing only bit transposition for the updated numeric data based on a predefined rule.

10. The pseudorandom number generation method as defined by claim 9, wherein
the internal state is updated
more frequently than a pseudorandom number sequence is output.

11. (canceled)

12. A pseudorandom number generation apparatus comprising:
a plurality of registers each holding data of a predetermined bit width;
a non-linear conversion means that receives a plurality of items of data stored respectively in the plurality of registers and performs non-linear conversion;
a transposition means that receives the plurality of items of data converted by the non-linear conversion means, divides each item of data into high-order bits and low-order bits, and that performs bit transposition in such a way that the high-order bits of one item of data are stored in the low-order bits of another item of data; and
a selector that is arranged between the non-linear conversion means and the transposition means, and that selects whether to supply the plurality of items of data, output from the non-linear conversion means, to the transposition means or to return the plurality of items of data to the plurality of registers, wherein
the plurality of items of bit-transposed data, output from the transposition means, are returned to the plurality of registers and held therein.

13. The pseudorandom number generation apparatus according to claim 12, wherein the non-linear conversion means is a multi-word T-function.

14. A key stream generation apparatus comprising:
first and second registers; and
another non-linear conversion means that receives first and second data from the first and second registers and that performs non-linear conversion for the first and second data as well as a plurality of items of data output from the non-linear conversion means or the transposition means of the pseudorandom number generation apparatus according to claim 12, wherein
the first and second registers are updated by the data output from the another non-linear conversion means and one stream of the data is output as a key stream.

15. A program causing a computer, which includes a plurality of registers, each holding data of a predetermined bit width, to execute:
a non-linear conversion processing that receives a plurality of items of data stored in the plurality of registers and performs non-linear conversion processing;
a transposition processing that receives the plurality of items of data converted by the non-linear conversion processing, divides each item of data into high-order bits and low-order bits, and performs transposition in such a way that the high-order bits of one item of data are stored in the low-order bits of another item of data, the plurality of items of bit-transposed data being returned to the plurality of registers and held therein; and
a selection processing that is executed between the non-linear conversion processing and the transposition processing, and that selects whether to supply the plurality of items of data, output from the non-linear conversion processing, to the transposition processing or to return the plurality of items of data to the plurality of registers.

16. The pseudorandom number generation program as defined by claim 15, wherein
the non-linear conversion processing is a multi-word T-function.

17. A key stream generation program causing a computer, which includes first and second registers, to execute:
another non-linear conversion processing that receives first and second data from the first and second registers and that performs non-linear conversion for the first and second data as well as a plurality of items of data output from the non-linear conversion processing or the transposition processing of the program as defined by claim 15; and
a processing that updates the first and second registers with the data output from the another non-linear conversion processing and outputs one stream of the data as a key stream.

18. A computer-readable recording medium in which the program as defined by claim 15 is recorded.

19. A pseudorandom number generation method comprising:
a non-linear conversion step of receiving a plurality of items of data stored in a plurality of registers, each holding data of a predetermined bit width, and performing non-linear conversion;
a transposition step of receiving the plurality of items of data converted by the non-linear conversion step, dividing each item of data into high-order bits and low-order bits, and performing bit transposition in such a way that the high-order bits of one item of data are stored in the low-order bits of another item of data; and
a selection step, located between the non-linear conversion step and the transposition step, of selecting whether to supply a plurality of items of data, output from the non-linear conversion step, to the transposition step or to return the plurality of items of data to the plurality of registers wherein
the plurality of items of bit-transposed data, output from the transposition step, are returned to the plurality of registers and held therein.

20. The pseudorandom number generation method as defined by claim 19 wherein
the non-linear conversion step is a multi-word T-function.

21. A key stream generation method comprising:
another non-linear conversion step that receives first and second data from first and second registers and that performs non-linear conversion for the first and second data as well as a plurality of items of data output from the non-linear conversion step or the transposition step of the pseudorandom number generation method as defined by claim 19 wherein
the first and second registers are updated by the data output from the another non-linear conversion step and one stream of the data is output as a key stream.
